(19) United States
(12) Patent Application Publication
(10) Pub. No.: US 2015/0258640 A1
(43) Pub. Date: Sep. 17, 2015

(54) METHOD AND APPARATUS FOR CUTTING A PILE

(71) Applicant: Norman Kenneth Aubin, Redwater (CA)

(72) Inventor: Norman Kenneth Aubin, Redwater (CA)

(21) Appl. No.: 14/656,425

(22) Filed: Mar. 12, 2015

Related U.S. Application Data
(60) Provisional application No. 61/952,071, filed on Mar. 12, 2014.

(51) Int. Cl. B23K 37/02

(52) U.S. Cl. CPC B23K 37/0276; B23K 37/0288; B23K 37/0282

(57) ABSTRACT

An apparatus and method for moving a tool around a pile comprising a grip for engaging upon the pile proximate to a top end thereof, a frame supported by the grip extending between top and bottom ends wherein and a tool holding head secured to a top of the frame. The apparatus further comprises at least one sensor secured to one of the frame or the grip adapted to sense an orientation of the pile, a processor means for determining a tool path around the pile and actuators for adjusting the frame during rotation about the pile to maintain the tool holding head along the tool path. The method comprises securing the grip to the pile proximate to a top end thereof, sensing an orientation of the pile, determining a tool path around the pile and rotating a top end of a frame about the pile.

### BACKGROUND OF THE INVENTION

1. Field of Invention

The present invention relates to construction in general and in particular to a method and apparatus for machining a pile.

2. Description of Related Art

A beveller is typically used to cut the edge of a piece for the sake of safety, wear resistance, aesthetics, or to facilitate connecting with another piece. Many different objects incorporate bevelled edges, including pipes. Some prior art pipe bevellers attach to the inside (using a mandrel) and/or the outside of a pipe with an end intended to have bevelled edges, or others clamp around the pipe, and some clamp onto the wall of the pipe. Some bevellers require manual processes where the beveller is moved around the pipe by hand as bevelling occurs. Bevelling may occur through the use of bits, teeth, torches, or other bevelling methods.

One object of beveling is often to maintain a consistently shaped and level slanted cut. This object can be frustrated by imperfections in pipe edges, imperfect dimensions, distortions due to environmental factors or aging of the pipes, such as warping caused by heating of the metal. Among other undesirable consequences, a non-level, imperfectly beveled, edge of a pipe may not be able to attach correctly with another pipe or other object. Consequently, several prior art devices have been created with the design of preventing such undesirable results by assisting a beveller maintain a consistent, level slanted cut. Most such bevellers attempt to accomplish this by levelling the pipe end with respect to the axes of the pipe. In addition, many beveling devices are large and unwieldy and hard to transport and therefore the pipes must usually be transported to those bevellers. Where transporting pipe to the large beveller is not possible or desirable, some prior art portable bevelling devices have also been created to allow bevelling in the pipe's field of use. Although not specifically related to bevelling, one problem faced by certain artisans is accurately determine the height or elevation that a pipe should reach or at which a pipe should be cut. A builder's leveler (possibly incorporating a bubble viol) may be used to assist in measuring the elevation at which the pipe was cut, or a laser (possibly incorporating a gimbal) may be used to indicate where a cut of the pipe should be made, but such devices and methods do not directly involve bevelling, and obviously do not perform bevelling in an automated fashion.

Although such prior art devices may well perform their intended functions as desired, certain beveling problems exist, depending on particular environments for beveled pipe edges. In particular, even where a pipe has been beveled in a level and accurate manner with respect to (i.e., or square to) the axes of the pipe, the pipe still may not be oriented properly to serve a particular purpose. For example, if the end of the pipe is intended to support a surface level to (or parallel to) a flat ground surface, even a beveled end that is level with respect to (i.e., “square to”) the pipe axes may not support the surface in the correct orientation where the pipe has not been mounted so that the pipe itself is pointing perfectly vertical. In particular, it is not unusual for pipes needing beveling to already be mounted or fixed in place (called “piles”) for further connecting with other pipes, or to support other objects or structures, yet not oriented perfectly with respect to the vertical axis of the Earth (the “true vertical”). Consequently, the ends of such piles, although possibly level with respect to (or square to) the pipe, may nevertheless not be aligned with the horizontal axis of the earth's surface (the “true horizontal”), and therefore adjustment beveling in order to prepare the pile ends for attaching to the other pipes or objects may be required.

Alternatively (and perhaps more commonly), such beveled edges of pipes may simply remain unleveled to the true horizontal, which can lead to various problems. For example, even where the desired elevation of the piles is more or less accurate, once pile caps are placed on the piles (a common practice in the oil industry), some pile caps may be a different angles than other pile caps. The resulting inaccuracies may create gaps between any structure (e.g., building, etc.) and the piles intended to support the structure. Extra work may be required to remedy the gaps. Moreover, if left uncorrected, as may often be the case, an uneven distribution of weight supported by the piles may result. In addition, such inaccuracies in true horizontal alignment may also in some cases result in a building not being at the proper elevation for tie in spools (i.e., small pipes connecting the building to a pipe rack).

Thus there is clearly a need for a beveller that bevels pipe edges in a manner that is level to the world rather than square to the pile (i.e., with respect to the axes of a pipe), and also a need for such a device that performs beveling in an automated manner. The apparatus and method described herein may bevel the edge of a pipe in a level manner with respect to non-pipe axes, such as for example the horizontal axis of the earth (level on the horizontal plane). One embodiment of the apparatus may be comprised of a pipe-attachment means, a means for determining the proper non-pipe axes, a pipe-end locating means, a beveller (as defined in the Description section below), and a means for adjusting the position of the beveller according to the location of the pipe end and the desired beveling to be accomplished in accordance with the appropriate non-pipe axes. For example, the non-pipe axes in many embodiments may comprise the horizontal axis of the earth (the true horizontal). In one embodiment, the position of the beveling means may be adjusted by beveling-position adjustment means, such as actuators. Beveling means (i.e., beveller), means for determining the non-pipe axes, and pipe-end locating means may be incorporated that are known to those skilled in the art(s) to which the invention pertains, and are not limited to the means comprising torches, gyroscopes, or sensors, respectively—although some embodiments may incorporate such particular means. For example, in one embodiment incorporating a beveling means comprising a torch, the means for adjusting the position of the torch may comprise three actuators: one that moves the torch up and down (or in one embodiment, with respect to the longitudinal axis of the pipe), one that moves the torch in and out (or in one embodiment, with respect to the latitudinal axis of the pipe), and one that adjusts the angle of the torch. In some embodiments, an actuator may also axially rotate the torch around the pipe and other embodiments may involve different manners of actuators for adjusting the position of a beveller. In one embodiment, the position of the actuators may be adjusted according to potentially the vertical and horizontal axes of the earth as determined by a gyroscope. In addition, the actuators that adjust the position of the torch (or other beveling means) may be concertedly controlled in one embodiment by a computer program that processes the information regarding the position of the pipe end and the proper non-pipe axis in order to determine the correct position of the torch, and to allow automated, self-levelling beveling to occur. In an embodiment incorporating a beveller comprising a torch and a means for determining the position of the pipe end comprising a sensor, the sensor may (but is not required to) be placed near the end of the torch. Regardless of the particular embodiment, beveling may occur for a pipe end that is mounted to a surface (i.e., a pile), but not in a perfecting upright position, so that the beveled edge of the not-perfectly upright pile is nevertheless aligned with the horizontal axis of the Earth (the true horizontal). Stated differently, the embodiments of the device and method described herein may enable not just leveling of a pipe end, but also beveling of a pipe end, with respect to a non-pipe axis (such as a true horizontal).

The above-described embodiments are considered that of some embodiments only. It is understood that the embodiments shown in the drawings below and described above are merely for illustrative purposes and not intended to limit scope. Alterations and modifications, therefore, and such further applications as would occur to those skilled in the relevant art(s), are also contemplated. For example, embodiments may have application for oxygen acetylene, oxygen propane, oxygen map gas, plasma cutting, edge cutting, flux core welding, etc. By way of further example, the beveller may comprise (instead of a torch) a flux core welder, plasma cutter with interchanging head, as to be used for welding (i.e., flux core) and/or gas metal arc welding (GMAW).

### SUMMARY OF THE INVENTION

According to a first embodiment of the present invention there is disclosed an apparatus for moving a tool around a pile comprising a grip for engaging upon the pile proximate to a top end thereof, a frame supported by the grip for rotation about the pile, the frame extending between top and bottom ends wherein and a tool holding head secured to a top of the frame. The apparatus further comprises at least one sensor secured to one of the frame or the grip adapted to sense an orientation of the pile, a processor means for determining a tool path around the pile and actuators for adjusting the frame during rotation about the pile to maintain the tool holding head along the tool path.

The tool path may lie along a plane. The plane may be substantially horizontal. The tool head may be adapted to hold a beveller. The tool head may be adapted to hold a welding head. The frame may rotate about the pile along the grip. The bottom end of the frame may be secured to the grip wherein the top end rotates about the pile.

The frame may comprise an arm. The frame may comprise a multi-segmented arm. The frame may comprise an upright member having a rotatable portion at a top end thereof.

According to a further embodiment of the present invention there is disclosed a method for moving a tool around a pile comprising securing a grip to the pile proximate to a top end thereof and sensing, utilizing at least one sensor secured to at least one of the grip or the frame an orientation of the pile. The method further comprises determining, utilizing a processor means, a tool path around the pile and rotating a top end of a frame supported by the grip about the pile wherein the top end includes a tool holding head.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus for bevelling a pipe according to a first embodiment of the present invention.

FIG. 2 is a side view of the apparatus of FIG. 1.

FIG. 3 is a control diagram of the apparatus of FIG. 1.

FIG. 4 is a perspective view of an apparatus for bevelling a pipe according to a further embodiment of the present invention.

### DETAILED DESCRIPTION

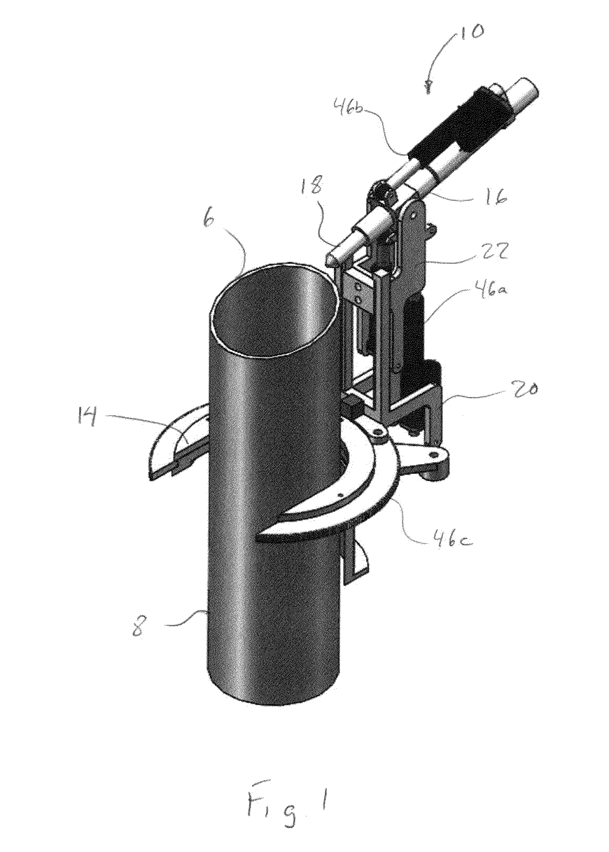

Referring to FIG. 1, an apparatus for machining an end 6 of a pipe 8 or pile according to a first embodiment of the invention is shown generally at 10. The apparatus 10 is securable to the pipe and includes a frame 12 supporting a tool holder 16 at a distal end thereof. The frame 12 is adapted to be rotated or otherwise moved around the pipe so as to move the tool holder 16 about the pipe so as to automatically cut or machine the pipe as described further below.

“Non-pipe axes determining means” is defined herein to refer to a means for determining at least one non-pipe axis. “Beveller” is defined herein to comprise bevelling means such as a cutting device, although as used in certain industries the term may commonly be used to comprise the combination of both a pipe-attaching means and a cutting device mounted thereof, and embodiments thereof.

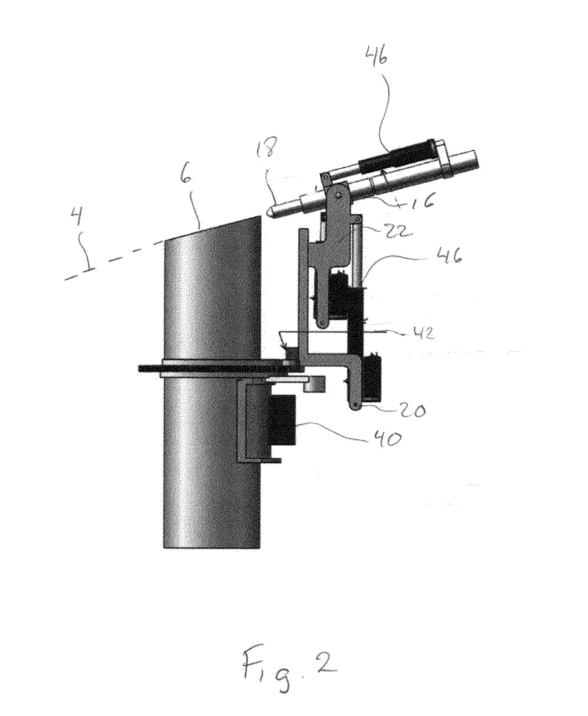

As illustrated in FIGS. 1 and 2, the apparatus 10 may include a pipe-attaching means 14, which in the embodiment shown may comprise a clamp or grip as are commonly known. A beveller 9 may be mounted to the pipe-attaching means 14, such as a clamp. The tool holder 16 may be adapted to hold any tool 18 for cutting or machining the pipe, such as, by way of non-limiting example, a torch, a beveller, a welder or the like. The frame 12 may be formed of a base or stationary member 20 secured to the grip 14 and a top portion 22 movable relative thereto. The stationary member 20 is secured to the grip and is adapted to be rotated around the pipe as set out below. The movable portion 22 is supported by and adapted to be moved relative to the stationary member 20 so as to adjust the height of the tool holder 16. It will be appreciated that sliders, linear bearings or other adjustable support means may be utilized for this purpose. The frame includes first second and third actuator, 46a, 46b and 46c, respectively for moving the tool holder 16 around the pipe at a position as determined below with adjustability for height, angle and position around the pipe respectively. As illustrated, the third actuator 46c may comprise a system (whether mechanical (using gears for example) and/or manually operated) for axially rotating or moving the tool holder 16 around the pipe 8.

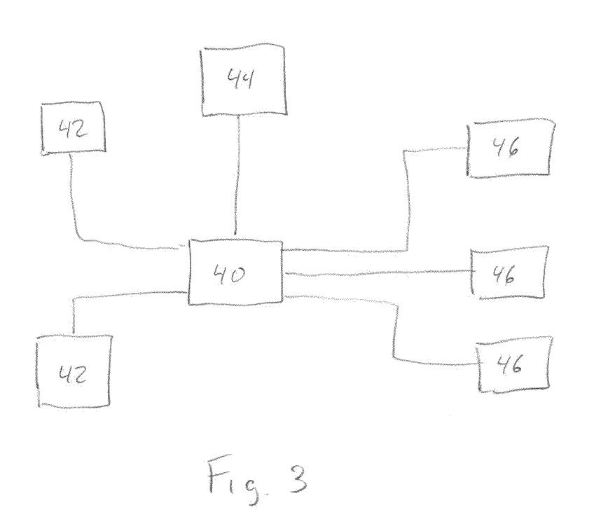

Turning now to FIG. 3, the apparatus includes a control system for controllably moving the tool holder 16 around the pipe. The system includes a processing circuit, at least one actuator, 46a, 46b and 46c and at least one sensor (such as, by way of non-limiting example, one comprising gimbals or a gyroscope) for determining the orientation of the apparatus 10 once affixed to the pipe. In the present embodiment, the processor circuit includes a microprocessor or other suitable processor circuit as are generally known in the art. More generally, in this specification, including the claims, the term “processor circuit” is intended to broadly encompass any type of device or combination of devices capable of performing the functions described herein, including (without limitation) other types of microprocessors, microcontrollers, other integrated circuits, other types of circuits or combinations of circuits, logic gates or gate arrays, or programmable devices of any sort, for example, either alone or in combination with other such devices located at the same location or remotely from each other, for example. Additional types of processor circuits will be apparent to those ordinarily skilled in the art upon review of this specification, and substitution of any such other types of processor circuits is considered not to depart from the scope of the present invention as defined by the claims appended hereto.

The processor circuit 40 is adapted to receive the position and orientation information provided by the sensors 42 and determine the desired cutting plane 4 as illustrated in FIG. 2 for the tool 18. As illustrated in FIG. 2, the cutting plane 4 may be oriented at an angle to the horizontal, however it will be appreciated that the cutting plane 4 may be horizontal wherein the present apparatus will adjust the position and angle of the tool 18 on a pipe which is at an angle to vertical. The apparatus may also incorporate sensors to determine the position of the pipe end 6 edges in order to maintain the tool 18 a consistent distance from the end 6 of the pipe 8.

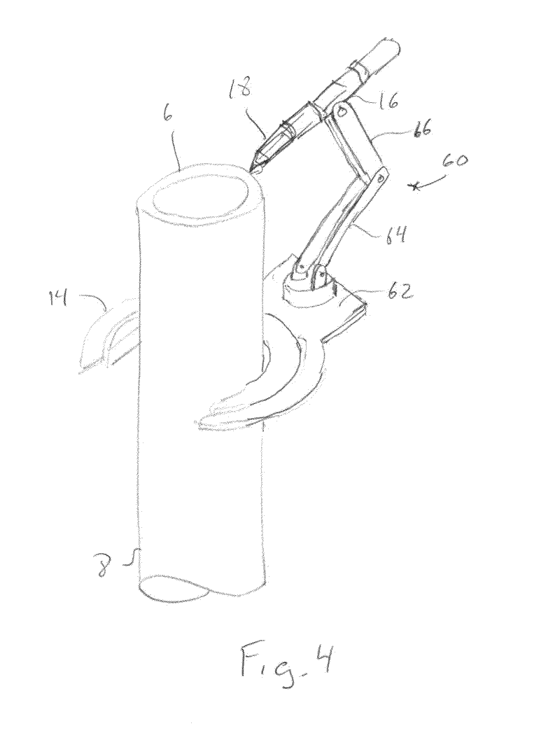

Turning to FIG. 4, an alternative embodiment of the present invention is illustrated in which the frame may comprise a robotic arm 60 supported on platform 62 secured to the grip 14. The robotic arm 60 may be formed of first and second arm portions, 64 and 66 and may be adapted to move the tool holder 16 about the pipe so as to cut or machine the pipe along the plane 4.

While specific embodiments of the invention have been described and illustrated, such embodiments should be considered illustrative of the invention only and not as limiting the invention as construed in accordance with the accompanying claims.

What is claimed is:

1. An apparatus for moving a tool around a pile comprising:
a grip for engaging upon the pile proximate to a top end thereof;
a frame supported by the grip for rotation about said pile, said frame extending between top and bottom ends wherein;
a tool holding head secured to a top of said frame;
at least one sensor secured to one of said frame or said grip adapted to sense an orientation of the pile;
processor means for determining a tool path around the pile; and
actuators for adjusting said frame during rotation about the pile to maintain said tool holding head along said tool path.

2. The apparatus of claim 1 wherein said tool path lies along a plane.

3. The apparatus of claim 2 wherein said plane is substantially horizontal.

4. The apparatus of claim 1 wherein said tool head is adapted to hold a beveller.

5. The apparatus of claim 1 wherein said tool head is adapted to hold a welding head.

6. The apparatus of claim 1 wherein said frame rotates about said pile along said grip.

7. The apparatus of claim 1 wherein said bottom end of said frame being secured to said grip wherein said top end rotates about said pile.

8. The apparatus of claim 7 wherein said frame comprises an arm.

9. The apparatus of claim 8 wherein said frame comprises a multi-segmented arm.

10. The apparatus of claim 6 wherein said frame comprises an upright member having a rotatable portion at a top end thereof.

11. A method for moving a tool around a pile comprising:
securing a grip to the pile proximate to a top end thereof;
sensing, utilizing at least one sensor secured to at least one of said grip or said frame an orientation of the pile;
determining, utilizing a processor means, a tool path around the pile; and
rotating a top end of a frame supported by said grip about said pile wherein said top end includes a tool holding head.
